(19) United States
(12) Patent Application Publication
(10) Pub. No.: US 2006/0032939 A1
(43) Pub. Date: Feb. 16, 2006

(54) Fire retardant management system

(75) Inventors: Robert G. Relyea, Dallas, TX (US); Grady C. North, Grapevine, TX (US)

Correspondence Address: JONES DAY, 77 WEST WACKER, CHICAGO, IL, 60601-1692, US

(73) Assignee: Crash Rescue Equipment Service, Inc., Dallas, TX (US)

(21) Appl. No.: 11/200,842

(22) Filed: Aug. 10, 2005

Related U.S. Application Data
(60) Provisional application No. 60/600,158, filed on Aug. 10, 2004.

(51) Int. Cl. A01G 27/00

(52) U.S. Cl. 239/68; 169/5

(57) ABSTRACT

A management system for controlling the dispensing of a fire fighting agent from a container in which a control device is used to select a desired rate of discharge of a fire fighting retarding agent from a container. The system includes a display in visual proximity to a user of the control device for visually indicating the selected flow rate of the fire retarding agent from the container. In addition, the system includes a visual display for indicating the time remaining, preferably in minutes and seconds, for the fire retarding agent in the container to be substantially completely expended. Alternatively, a synthesized voice may announce the time remaining at predetermined intervals such as every 5 seconds. Finally, a visual display, preferably in the form of a bar graph, gives the real time physical level of the fire retarding agent remaining in the container at any given time.

This application claims the benefit of U.S. Provisional Application Ser. No. 60/600,158, filed on Aug. 10, 2005.

### BACKGROUND OF THE INVENTION

1. Field of the Invention

The present invention relates in general to fire fighting systems and in particular to a method and apparatus for enabling a user of the system to effectively and efficiently utilize the fire fighting fluid in a container.

2. Description of the Known Prior Art

It is obvious that in a fire fighting system, particularly with a container or a tank forming part of a fire truck, the amount of fire retarding agent or fluid available to attempt to put the fire out is limited to the size of the tank.

Generally speaking, the user of the system can select a desired flow rate or rate of discharge of the fire retarding agent from the container. If there is a first flow rate and then a second higher flow rate, the operator or user can select a desired one of the flow rates for a particular.

At the highest flow rate, the fire retarding agent in a conventional tank may last only two minutes. Thus, during the hectic activities that occur while fighting a fire, the operator or user may not realize how long the fire retarding agent has been flowing at the high rate and thus the fluid may be substantially completely expended before the operator or user is aware. If the operator had remembered that the fluid was flowing at the highest rate and if he had known when there was one minute of flow remaining, a lower flow rate could have been selected or a different area of the fire confronted thus enabling the operator to efficiently use, conserve, and prolong the discharge of the fire retarding agent.

Thus, it would be advantageous to have a display in visual proximity to the user or operator that would provide a visual indication of the selected rate of discharge of the fire retarding agent such that the operator does not have to try to remember the flow rate of the fire retarding agent that has been selected.

Further, if the display provided to the operator the time remaining for substantially complete dispensing of the fluid in the container or tank, the operator could make an informed judgment as to the rate of fluid flow that would be desired to efficiently use, conserve, and prolong the discharge of the fire retarding agent.

Finally, it would be advantageous if the operator could see a graph on a display that showed in real time the level of the fluid remaining in the tank or container at any given time. The operator would then have a clear indication of how much fluid is remaining in the tank and how fast it is being used. If necessary, the operator could then select a slower discharge rate to prolong the discharge time of the fire retarding agent.

### SUMMARY OF THE INVENTION

The present invention relates to a management system for controlling the rate of discharge of a fire retarding agent from a container with the real time use of pertinent information given to the operator of the system. Thus during the hectic moments of fighting the fire, the operator has a display within visual proximity that has thereon, in a digital read out, the time remaining, in minutes and seconds, for substantially complete dispensing of the fire retarding agent in a container or tank.

As an additional aide, the display may have associated therewith a voice synthesizer that can orally state, at any predetermined interval such as each 5 seconds, the time remaining, in minutes and seconds, for substantially complete dispensing of the fire retarding agent in the container or tank.

It may also include an LCD bar graph (color or otherwise) for representing the actual level of the fluid remaining in the container or tank such that the operator can see the relative level of the fluid in the tank at any given time and can see how much of the fluid is remaining therein.

Also, the display may include at least two different colored lights (LED's) for indicating which rate of discharge of the fire retarding agent has been selected.

Finally, since most fire fighting devices such as trucks have an auxiliary tank or container that is charged with an auxiliary fire fighting agent, the display may have LED's that indicate if the auxiliary tank is charged and available for use.

Thus it is an object of the present invention to provide a management system for controlling the rate of discharge of a fire fighting retardant from a tank or container based on information provided on a display.

It is another object of the present invention to provide visual information for the operator that visually indicates to the user the selected rate of discharge of the fluid in a container.

It is yet another object of the present invention to provide to the operator, either visually or orally or both, the time remaining, in minutes and seconds, until the fluid in the tank is completely expended.

It is still another object of the present invention to provide an LCD bar graph display representing the actual level of the fluid in the tank so that the operator has a visual perception of the fluid remaining in the tank at any given time.

It is also an object of the present invention to provide a display for the operator that visually indicates the charged or discharged status of any auxiliary tank that may be available to the operator.

Thus, the novel invention relates to a management system for controlling the dispensing of a fire retarding agent from a container comprising a control device for enabling a user to select a desired rate of discharge of the fire retarding agent from the container and a display in visual proximity to the user of the control device for presenting a visual indication to the user of the selected rate of discharge of the fire retarding agent from the container.

The invention also relates to a management system for controlling the dispensing of a fire retardant agent from a container in which a control device is used to select a desired rate of discharge of the fire retarding agent from the container, and in which a display is in visual proximity to the user of the control device provides to the user the time remaining, in minutes and seconds, for the fire retarding agent in the container to be substantially completely expended at the existing selected rate of discharge such that the user of the control device can constructively change the rate of discharge of the fire retarding agent from the container based on the indications from the display to efficiently use, conserve, and prolong the dispensing of the fire retarding agent.

The invention also relates to a management system for controlling the rate of discharge of a fire fighting agent from a container and in which an LCD bar graph display provides a visual indication to the user of the control device of the relative level of the fluid remaining in the container at any given time so that the operator or user can visually observe the fluid level and the rate at which it is being dispensed.

The invention further relates to a management system for controlling the rate of discharge of a fire fighting agent from a container in which a display provides a visual indication to the user, in digital form, of the time remaining, in minutes and seconds, for the fluid in the container, at the selected flow rate, to be substantially completely expended.

The invention also relates to a management system for controlling the rate of discharge of a fire fight agent, or fluid, from a container in which a voice synthesizer circuit associated with the display orally announces the time remaining, in minutes and seconds, for the fire retarding agent in the container to be substantially completely expended.

### BRIEF DESCRIPTION OF THE DRAWINGS

These and other more specific objects of the invention will be disclosed when taken in conjunction with the Detailed Description of the Drawings in which like numerals represent like objects and in which:

FIG. 1 is a diagrammatic representation of the present invention; and

FIG. 2 is an enlarged view of the visual display of the present invention.

### DETAILED DESCRIPTION OF THE DRAWINGS

In the following description of the invention, it is to be understood that the term “fire retarding agent” is intended to mean “fluid” or any other fire fighting medium that can be discharged from a container during the fire fighting operation. The term “tank” or “container” is intended to mean a “stationary” tank or container or a “portable” tank or container such as would be found on a fire fighting truck or fire engine.

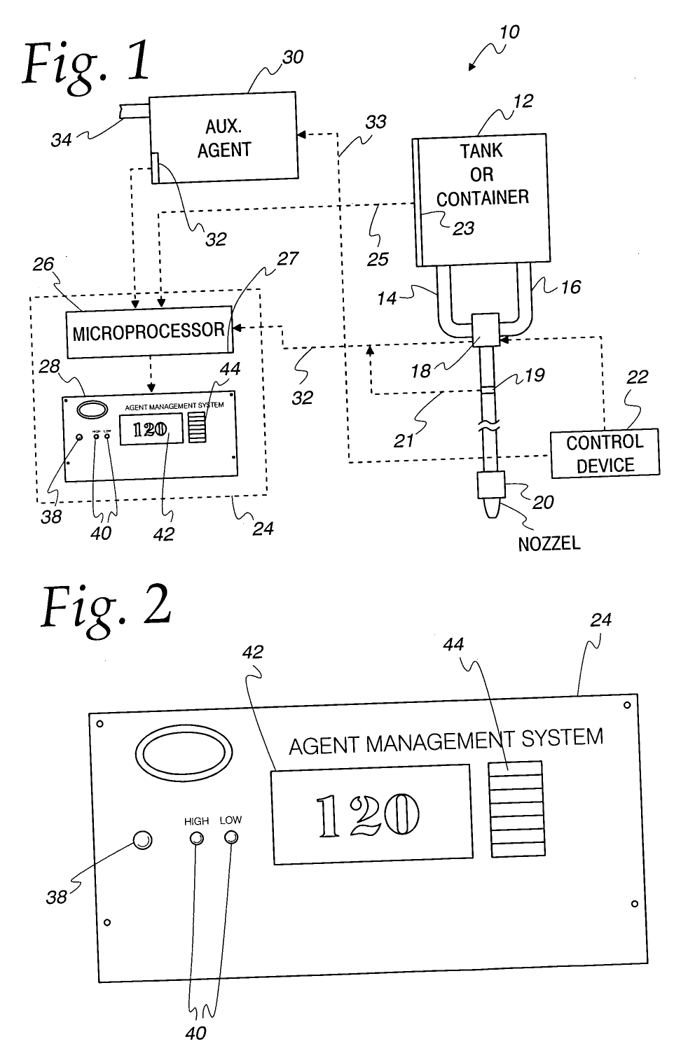

As can be seen in FIG. 1, the novel system 10 comprises a tank or container 12 that contains a fire retardant that is to be dispensed or discharged on or towards a fire. The tank 12 may have an outlet conduit 14 and an outlet conduit 16 that are connected to a selector valve 18 controlled by a control device 22. By selectively controlling valve 18, the operator may select a first rate of discharge of the fire retarding agent or a second higher discharge rate. Typically speaking, there is a “high” discharge rate and a “low” discharge rate. When discharging the fire retardant at the “high” discharge rate, the fire fighting retardant in the tank 12 may be substantially totally expended in just two minutes. The operator must, therefore, remember the selected discharge rate so that the length of time remaining to use the fire extinguishing agent before it is entirely expended can be anticipated. Further, during the chaotic moments of fighting the fire, it is difficult for the operator to remember whether the flow rate is “high” or “low”.

With the present invention, a visual display panel 24 is provided that has on it an indicator, preferably in the form of an LED, that lights to indicate that tank 30, holding an auxiliary agent, is charged and ready to go.

It also has indicators 40, preferably in the form of LED's, to light to indicate “high” flow and “low” flow rates. If, for example only, the LED on the left is lit, it may indicate that the operator has selected the “high” flow rate. If the LED on the right is lit, it may indicate that the operator has selected the “low” flow rate. This feature can be realized in many ways. For instance, valve 18 may have a sensor thereon that recognizes the position in which the valve 18 located. Signals are then generated in a well known fashion on line 32 to a microprocessor 26 associated with the visual indicator panel to cause the appropriate light to be energized. Of course, instead of having two discharge conduits 14 and 16 coupled between the container or tank 12 each with its own “high” or “low” discharge rate, a single conduit may be coupled between the container 12 and the discharge nozzle 20 with a two speed pump in the conduit. The operator, with the control device 22, can then select the desired speed of the pump to produce either a “high” discharge or flow rate or a “low” discharge or flow rate. Again, a sensor, well known in the art, can detect which pump speed has been selected and send a signal on line 21/32 to the microprocessor 26. There are many available types of sensors such as flow rate sensors 19, pump speed sensors, and the like that could be used to generate the signal on line 32 to the microprocessor 26 to indicate the “high” or “low” discharge rate selection.

A feature of great importance to the operator is the time remaining until the fire retarding agent in the tank 12 is substantially completely expended. This is readily accomplished for a given volume tank and a known flow discharge rate of the fire retarding agent. The microprocessor 26 can be programmed to calculate the remaining time for the fire retarding agent in the tank or container 12 to be completely expended at a given flow rate. This time can then be indicated on the panel 28 of the visual display 24 in seconds, minutes and seconds, or in any desired units preferably with an LCD display 42. In this manner the operator has before his eyes an indication of much fire retardant agent discharge time is left. There is no longer any guess involved.

In addition, or alternatively, voice synthesizer 27 could be associated with the microprocessor 26 and the visual display and the time remaining could be orally announced at any desired predetermined interval such as each 5 seconds, or each 10 seconds. Such synthesizers are old and well known in the art and will not be explained here.

Of further importance to the operator is the visual perception of how much fire retardant agent is in the tank or container 12 at any given time. This information is supplied in the present invention by placing a tank fill indicator 23 in the container 12 to sense the level of the fire retardant agent and generate a signal on line 25 to the microprocessor 26 that is used to generate a bar graph tank level gauge 44 that shows by means of bars, in a well known fashion, the level of the fire retardant agent remaining in the tank 12 at any given time. The bar graph 44 is shown in FIG. 2 as a horizontal bar graph. However, it is preferred that the bar graph be shown vertically so that it is moving downwardly as the fire retardant agent is being expended.

With the novel arrangements discussed above, there is no guess work or remembering for the operator. The display 24 is placed within visual proximity of the operator, for instance on the dash of a fire engine, so that as the operator is looking in a forward direction toward the fire, the display 24 is readily visible. If the operator wishes to efficiently use, conserve, and prolong the discharge of the fire retarding agent, a “low” level of discharge rate can be selected with the control device.

The auxiliary agent tank 30 has associated therewith a discharge conduit 34 that, of course, is coupled to a discharge nozzle. It also has a sensor 32 associated therewith to determine that the tank 30 is charged and ready to go. The sensor output is coupled to microprocessor 26 which then causes indicator 38 to be energized (LED on) to indicate a fully charged tank 30 or causes indicator 38 to be de-energized (LED off) to indicate that there is no fire retarding agent available in the auxiliary tank 30.

Thus, there has been disclosed a novel management system for controlling the dispensing of a fire retardant from a container to enable the operator to efficiently use, conserve, and prolong the discharge of, the fire retarding agent.

The system includes a display in visual proximity to the operator of a control device the visually indicates the selected rate of discharge of the fire retarding agent from a tank, container, or other known quantity source. It also provides the time remaining for the fire retarding agent in tank 12 to be substantially completely expended based upon the selected flow rate of the fire retarding agent. This information is given either orally or as a display or both.

Further, the system provides a reference on the display, preferably in the form of a bar graph that visually indicates the substantial real time level of the fire retarding agent in the tank at any given time.

While the invention has been set forth in relation to specific embodiments, it is to be understood that certain changes may be made in the novel invention without departing from the scope of the invention and it is intended that all matter contained in the above description or shown in the accompanying drawings are to be interpreted as illustrative and not in a limiting sense.

It is also to be understood that the following claims are intended to cover the generic and specific features of the invention herein described.

1. A management system for controlling the dispensing of a fire retarding agent from a container comprising:
a control device for selecting a desired rate of discharge of the fire retarding agent from the container; and
a display in visual proximity to a user of the control device for visually indicating the selected rate of discharge of the fire retarding agent from the container such that the user of the control device knows the selected rate of discharge of the fire retarding agent based on the indication on the visual display.

2. A management system for controlling the dispensing of a fire retarding agent from a container comprising:
a control device for selecting a desired rate of discharge of the fire retarding agent from the container; and
a display in visual proximity to a user of the control device for visually indicating the selected rate of discharge of the fire retarding agent from the container and providing the time remaining, in minutes and seconds, for the selected fire retarding agent in the container to be completely expended at the selected rate of discharge such that the user of the control device can constructively change the rate of discharge of the fire retarding agent from the container based on the indications from the visual display to efficiently use, conserve, and prolong the dispensing of, the fire retarding agent.

3. A management system for controlling the rate of discharge of a fire retarding agent from a container comprising:
a control device for selecting a desired rate of discharge of the fire retarding agent from the container; and
a display in visual proximity to a user of the control device for visually indicating the selected flow rate of the fire retarding agent from the container, for providing the time remaining, in minutes and seconds, for the fire retarding agent in the container to be substantially completely expended, and for displaying the real time level of the fire retarding agent remaining in the container at any given time such that the user of the control device can select a desired flow rate of the fire retarding agent from the container based on the indications from the display to efficiently use, conserve, and prolong the discharge time of the fire retarding agent.

4. A management system for controlling the dispensing of a fire retarding agent from a container comprising:
a control device for selecting a desired rate of discharge of the fire retarding agent from the container by selecting one of a first discharge rate and a second higher discharge rate; and
a display in visual proximity to a user of the control device for visually indicating the selected rate of discharge of the fire retarding agent from the container such that the user of the control device can select a different rate of discharge of the fire retarding agent based on the indication on the visual display and thereby efficiently use, conserve, and prolong the discharge of the fire retarding agent.

5. A management system for controlling the dispensing of a fire retarding agent from a container comprising:
a control device for selecting a desired rate of discharge of the fire retarding agent from the container;
a sensor associated with the container for generating a signal representing the selected rate of discharge of the fire retarding agent;
a calculator circuit coupled to the sensor for calculating the time remaining, in minutes and seconds, based on the size of the container and the selected rate of discharge, for the fire retarding agent in the container to be substantially completely expended; and
a display in visual proximity to a user of the control device and coupled to the calculator circuit for visually indicating the selected rate of discharge of the fire retarding agent from the container and for providing the time remaining, in minutes and seconds, for the selected fire retarding agent in the container to be completely expended at the selected rate of discharge such that the user of the control device can change the rate of discharge of the fire retarding agent from the container based on the indications from the display to efficiently use, conserve, and prolong the discharge of, the fire retarding agent.

6. A management system for controlling the dispensing of a fire retarding agent from a container comprising:
a control device for selecting a desired rate of discharge of the fire retarding agent from the container; and
a display in visual proximity to a user of the control device for visually indicating the selected flow rate of the fire retarding agent from the container, for providing the time remaining, expressed in minutes and seconds, for the fire retarding agent in the container to be substantially completely expended at the selected flow rate, and giving a visual indication of the real time physical level of the fire retarding agent remaining in the container at any given time with the use of a bar graph container level gauge such that the user of the control device can change the flow rate of the fire retarding agent from the container based on the indications from the visual display to regulate the control of the flow rate of the fire retarding agent to efficiently use, conserve, and prolong the discharge of, the fire retarding agent in the container.

7. The management system of claim 1 further including:
first and second colored indicator lights on the display for visually notifying the user of a selected one of the first flow rate and the second higher flow rate.

8. The management system of claim 5 further including:
a microprocessor forming said calculator circuit; and
a digital readout on the visual display coupled to the microprocessor for indicating the time remaining, in minutes and seconds, for the fire retarding agent in the container to be substantially completely expended.

9. The management system of claim 8 further including:
a circuit associated with the microprocessor for generating a synthesized voice to orally state the time remaining, in minutes and seconds, for the fire retarding agent in the container to be substantially completely expended

10. The management system of claim 5 further including:
an LCD bar graph on the display, and coupled to the microprocessor, for visually indicating the real time physical level of the fire retarding agent remaining in the container at any given time.

11. The management system of claim 1 further including:
an auxiliary fire retarding agent status indicator light associated with said display for visually notifying the user of the charged or discharged state of an auxiliary fire retarding agent container.

12. A method of controlling the rate of discharge of a fire retarding agent from a container comprising the steps of:
selecting a desired rate of discharge of the fire retarding agent with a control device; and
visually indicating to the user of the control device the selected rate of discharge of the fire retarding agent from the container such that the user is visually informed of the selected rate of discharge of the fire retarding agent.

13. A method of controlling the discharge of a fire retarding agent from a container comprising the steps of:
selecting the rate of discharge of the fire retarding agent with a control device;
providing a display for visually indicating the rate of discharge of the fire retarding agent; and
placing the display in visual proximity of a user of the control device such that the user is visually informed of the selected desired rate of discharge of the fire retarding agent by means of the indication from the display.

14. A method of controlling the discharge of a fire retarding agent from a container comprising the steps of:
selecting the rate of discharge of the fire retarding agent from the container with a control device;
providing a display for visually indicating the rate of discharge of the fire retardant agent from the container and for providing the time remaining, in minutes and seconds, for the retarding agent in the container to be substantially completely expended; and
placing the display in visual proximity of a user of the control device such that the user is informed of the selected rate of discharge of the fire retarding agent such that a decision to change the rate of discharge of the fire retarding agent can be made based on the indications from the display.

15. A method of controlling the discharge of a fire retarding agent from a container comprising the steps of:
selecting the rate of discharge of the fire retarding agent from the container with a control device;
providing a display for visually indicating the rate of discharge of the fire retarding agent from the container, for providing the time remaining, in minutes and seconds, for the retarding agent in the container to be substantially completely expended, and for visually indicating the real time physical level of the remaining fire retarding agent in the container at any given time; and
placing the display in visual proximity of a user of the control device such that the user can change the rate of discharge of the fire retarding agent with the control device based on the indications from the display.

16. A method of controlling the discharge of a fire retarding agent from a container comprising the steps of:
selecting the rate of discharge of the fire retarding agent from the container by selecting one of a first discharge rate and a second higher discharge rate with a control device;
providing a display for visually indicating the selected rate of discharge of the fire retardant agent from the container and for providing the time remaining, in minutes and seconds, for the fire retarding agent in the container to be substantially completely expended; and
placing the display in proximity to a user of the control device such that the user can change the desired rate of discharge of the fire retarding agent with the control device based on the indications from the visual display.

17. A method of constructively controlling the dispensing of a fire retarding agent from a container comprising the steps of:
selecting a desired rate of discharge of the fire retarding agent from the container with a control device;
associating a sensor with the container for generating a signal representing the selected flow rate;
coupling a calculator means to the flow rate sensor for calculating the time remaining, in minutes and seconds, based on the container size and the selected rate of discharge of the fire retarding agent, for the fire retarding agent in the container to be substantially completely expended;
coupling a display to the calculator circuit for visually indicating to the user of the control device the selected rate of discharge of the fire retarding agent from the container and for providing the time remaining, in minutes and seconds, for the fire retarding agent in the container to be substantially completely expended with continued use at the selected discharge rate such that the user of the control device is informed of the selected discharge rate and the time remaining for complete discharge of the fire retarding agent in the container at the selected discharge rate to enable the user to constructively change the rate of discharge of the fire retarding agent from the container based on the indications from the display to efficiently use, conserve, and prolong the discharge of the fire retarding agent.

18. A method of constructively controlling the dispensing of a fire retarding agent from a container comprising the steps of:
selecting a desired rate of discharge of the fire retarding agent from the container with a control device;
visually indicating to a user of the control device the selected discharge rate of the fire retarding agent from the container;
providing for the user of the control device the time remaining, expressed in minutes and seconds, for the selected fire retarding agent in the container to be substantially completely expended at the indicated discharge rate; and
visually indicating the real time physical level of the fire retarding agent remaining in the container at any given time with the use of a bar graph container level gauge such that the user of the control device can change the discharge rate of the fire retarding agent from the container based on the indications from the display to efficiently use, conserve, and prolong the discharge of the fire retarding agent.

19. The method of claim 12 further comprising the step of:
visually notifying the user of the control device of the selected one of the first flow rate and the second higher flow rate with the use of first and second colored lights on the display.

20. The method of claim 16 further comprising the steps of:
forming the calculator circuit in a microprocessor; and
coupling a digital readout on the display to the microprocessor for visually indicating the time remaining, in minutes and seconds, for the fire retarding agent in the container to be substantially completely expended.

21. The method of claim 16 further comprising the steps of:
forming the calculator circuit in a microprocessor; and
generating a synthesized voice with a display circuit coupled to the microprocessor to orally state, at predetermined time intervals, the time remaining, in minutes and seconds, for the fire retarding agent in the container to be substantially completely expended.

22. The method of claim 16 further including the step of:
coupling an LCD bar graph on the display to the microprocessor for visually indicating the physical level of the fire retarding agent remaining in the container at any given time.

23. The method of claim 12 further comprising the step of:
visually notifying the user of the control device of the charged or discharged state of an auxiliary fire retarding agent container associated with the management system.
